(19) United States
(12) Patent Application Publication
(10) Pub. No.: US 2009/0244034 A1
(43) Pub. Date: Oct. 1, 2009

(54) Computer input device and method for controlling direction of operation target using the same

(75) Inventors: Chien-Cheng Chen, Taipei County (TW); Cheng-Che Tsai, Taipei County (TW); Chien-Hsing Tsai, Taipei County (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei County (TW)

(21) Appl. No.: 12/213,403

(22) Filed: Jun. 19, 2008

(30) Foreign Application Priority Data
Mar. 26, 2008 (TW) 097110762

(51) Int. Cl. G06F 3/045

(52) U.S. Cl. 345/175

(57) ABSTRACT

A computer input device and a method for controlling a direction of an operated target using the same are described. The computer input device includes an optical touch control module, a motion look-up table, and look-up corresponding motion. The motion look-up table records a user's operations made on the optical touch control module and corresponding motions performed accordingly. The motion look-up is executed to record a finger touch area where a finger touches the optical touch control module within a certain time period, to look up the motion look-up table for the corresponding motion to be performed according to the finger touch area and the record about a previous touch area, and to perform the corresponding motion to control the direction of the operated target.

### CROSS-REFERENCE TO RELATED APPLICATIONS

This non-provisional application claims priority under 35 U.S.C. §119(a) on Patent Application No(s). 097110762 filed in Taiwan, R.O.C. on Mar. 26, 2008 the entire contents of which are hereby incorporated by reference.

### BACKGROUND OF THE INVENTION

1. Field of the Invention

The present invention relates to an input device and an operation method thereof, and more particularly to a computer input device and a method for controlling a direction of an operated target using the same.

2. Related Art

Computer games are applications executed in a computer for the purpose of entertainment. With the rapid progress of computer technology, pictures in the computer game become increasingly delicate, and the operating manner gets increasingly complicated. Most of the computer games are controlled by a mouse and a keyboard. Taking the third-person shooter, a very popular computer game for example, the protagonists in the game often make important spin motions, which are generally accomplished through complicate keyboard motions that are unfamiliar to the game players. Therefore, at the initial stage, the players have to exert great efforts to remember the operation manners and spend plenty of time to get accustomed to those complicated operation manners.

As for some impatient players, the complicated operation manners of the computer games often bring great obstacles in learning, and as a result, those computer games make the players feel frustrated instead of feeling enjoyable. Moreover, such computer game still requires the players to make interactive operations with both a keyboard and a mouse for controlling the game, so the players must operate the keyboard with one hand and the mouse with the other hand. If the player wants to answer a cell phone when playing a computer game, he/she must stop the game. Therefore, if the operations are integrated into a single input device, and the player is provided with an intuitive operation, the difficulty in learning to play a computer game is reduced, and the player may soon enjoy the computer game.

### SUMMARY OF THE INVENTION

Accordingly, in order to solve the problem of inconveniences in manipulation due to complicated operation manners in the above computer game software, the present invention is directed to a computer input device for controlling a moving direction of an operated target. The present invention is also directed to a method for controlling a direction of an operated target through using a computer input device. By mounting an optical touch control module (TC module) on a mouse device, the user may depict a track with an index finger to control the moving direction of an operated target in computer game software.

In order to achieve an objective of the present invention, a computer input device provided in the present invention includes an optical touch control module, a motion look-up table, and a corresponding motion look-up means. The motion look-up table records a user's operations at the optical touch control module and corresponding motions performed accordingly. The motion look-up means controls a direction of an operated target according to a finger touch motion received by the optical touch control module. In addition, the motion look-up means further includes the following steps: recording a finger touch area where a finger touches the optical touch control module within a certain time period, and looking up the motion look-up table for the corresponding motion to be performed according to the finger touch area and the record of a previous touch area, and finally, performing the corresponding motion to control the direction of the operated target.

In the computer input device according to a preferred embodiment of the present invention, the corresponding motion includes rotating leftward by 90 degrees, rotating rightward by 90 degrees, and rotating by 180 degrees. The finger touch area is any one of several areas divided on the touch module.

In the computer input device according to a preferred embodiment of the present invention, a firmware further initializes the previous touch area into any one of the areas divided on the touch module. Moreover, the firmware analyzes the corresponding motion by utilizing the motion look-up table, and then stores the current finger touch area as the previous touch area. In addition, the firmware further determines the corresponding motion to be performed according to a depicted curve of the finger touch motion. Relations between the curve and the corresponding motion are listed as follows: when the curve is a clockwise 90-degree curve, the motion is to rotate rightward by 90 degrees; when the curve is an anticlockwise 90-degree curve, the motion is to rotate leftward by 90 degrees; when the curve is a clockwise 180-degree curve, the motion is to rotate by 180 degrees; and when the curve is an anticlockwise 180-degree curve, the motion is to rotate by 180 degrees.

In order to achieve the other objective of the present invention, a method for controlling a direction of an operated target through using a computer input device provided in the present invention further includes the following steps: first, detecting a finger touch motion received by an optical touch control module of a mouse device; next, obtaining a finger touch area where a finger touches the optical touch control module; then, analyzing the corresponding motion to be performed through utilizing a motion look-up table according to the finger touch area and a previous touch area; and finally, performing the corresponding motion to control the direction of the operated target.

In the method for controlling a direction of an operated target through using a computer input device according to a preferred embodiment of the present invention, the corresponding motion includes rotating leftward by 90 degrees, rotating rightward by 90 degrees, and rotating by 180 degrees. The finger touch area is any one of several areas divided on the touch module.

In the method for controlling a direction of an operated target through using a computer input device according to a preferred embodiment of the present invention, a firmware further initializes the previous touch area into any one of the areas divided on the touch module. Moreover, the firmware analyzes the corresponding motion by utilizing the motion look-up table, and then stores the current finger touch area as the previous touch area. In addition, the firmware further determines the corresponding motion to be performed according to a depicted curve of the finger touch motion. Relations between the curve and the corresponding motion are listed as follows: when the curve is a clockwise 90-degree curve, the motion is to rotate rightward by 90 degrees; when the curve is an anticlockwise 90-degree curve, the motion is to rotate leftward by 90 degrees; when the curve is a clockwise 180-degree curve, the motion is to rotate by 180 degrees; and when the curve is an anticlockwise 180-degree curve, the motion is to rotate by 180 degrees.

In view of the above, according to the computer input device and the method for controlling a direction of an operated target through using the computer input device in the present invention, an optical touch control module is mounted on the computer input device, which is provided for the user to depict a track thereon with an index finger, so as to control the operated target to turn around. For example, when the user depicts from the right end to the left end of the optical touch control module, it indicates turning the operated target by 180 degrees, or when the user depicts a track of clockwise rotation by 90 degrees, it indicates controlling the operated target to rotate rightward by 90 degrees, thereby achieving an intuitive control.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a computer input device;

FIG. 2 is a schematic view of an optical touch control module of a mouse and several areas divided thereon;

FIG. 3 is a flow chart of a method for controlling a direction of an operated target through using a computer input device;

FIG. 4 shows a motion look-up table;

FIG. 5 is a flow chart of a method for controlling a direction of an operated target according to an embodiment of the present invention; and

FIGS. 6A to 6D are schematic views for controlling a direction of an operated target.

### DETAILED DESCRIPTION OF THE INVENTION

The device and the connection method of the present invention are illustrated in detail below through preferred embodiments. However, the concept of the present invention may also be applied to other scopes. In the following embodiments, an optical touch control module (TC module) of the present invention includes a shell with a light source and an optical sensor disposed therein, and a light pervious element disposed on one end toward the light source and the optical sensor. A finger of the user can slide on the light pervious element to generate a corresponding control (tracking) signal. The related arts can be obtained with reference to U.S. Pat. No. 7,298,362.

The embodiments are only intended to illustrate the objectives and implementations of the present invention, but not to limit the scope thereof.

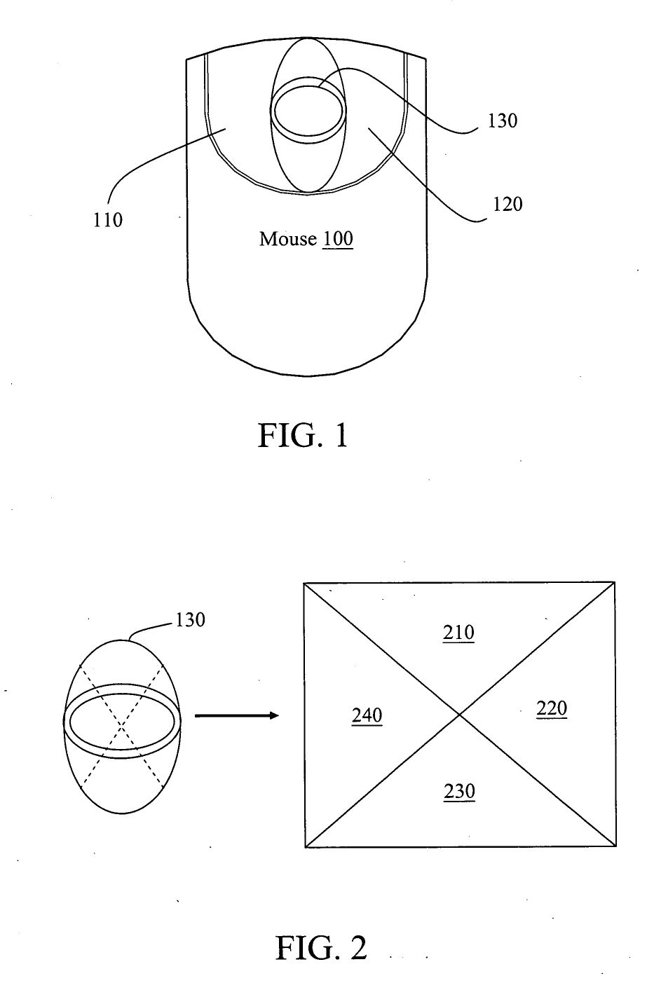

FIG. 1 is a schematic view of a computer input device. Referring to FIG. 1, in this embodiment, the computer input device is a mouse 100 having a left mouse button 110, a right mouse button 120, and an optical touch control module 130 for transmitting a mouse signal to the computer. The optical touch control module 130 is mounted between the left mouse button 110 and the right mouse button 120 to replace the scroll wheel of the mouse 100, which facilitates the user to depict a track on the optical touch control module 130 with an index finger. In another embodiment, the optical touch control module 130 may also be mounted on the left or right side of the shell of the mouse 100, such that the user can depict a track with a thumb or other fingers. Furthermore, the computer input device includes a firmware for executing a corresponding motion look-up means. The motion look-up means is executed to control the direction of an operated target according to a finger touch motion received by the optical touch control module 130. The firmware is operated by a microprocessor of the computer or a microprocessor embedded in the mouse, so as to control the direction of the operated target according to the finger touch motion received by the optical touch control module 130.

Accordingly, the above firmware is operated by a microprocessor of the computer, which further includes the following steps: first, detecting a finger touch motion; obtaining a finger touch area where a finger touches the optical touch control module, and then analyzing the corresponding motion to be performed through utilizing a motion look-up table according to the finger touch area and a previous touch area; and then performing the corresponding motion to control the direction of the operated target.

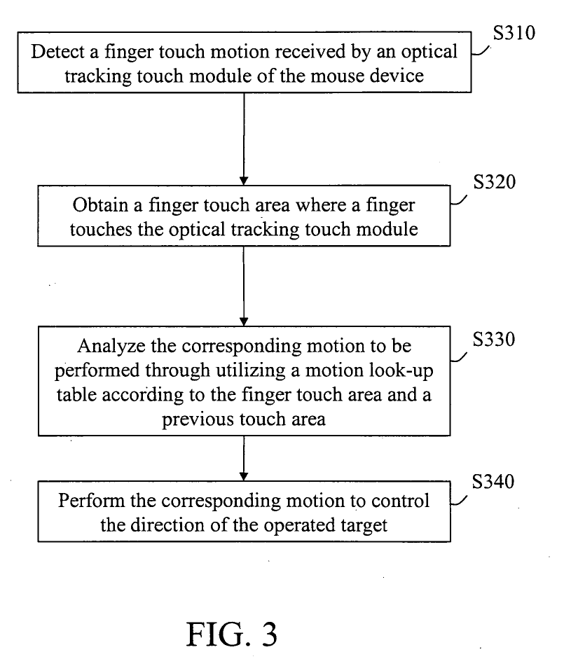

FIG. 2 is a schematic view of an optical touch control module of a mouse and several areas divided thereon. Referring to FIG. 2, the optical touch control module 130 is divided into several areas, and each area is corresponding to a virtual area. In this embodiment, the optical touch control module 130 is divided into four finger touch areas. For example, the upper portion of the optical touch control module 130 is corresponding to a first area 210, the right portion of the optical touch control module 130 is corresponding to a second area 220, the lower portion of the optical touch control module 130 is corresponding to a third area 230, and the left portion of the optical touch control module 130 is corresponding to a fourth area 240. When the user depicts a track on the optical touch control module 130 with an index finger, the corresponding motion to be performed is determined according to the depicted track, and then, the corresponding motion is performed to control the direction of an operated target in the application software. In addition, the corresponding motion may be, for example, rotating leftward by 90 degrees, rotating rightward by 90 degrees, or rotating by 180 degrees.

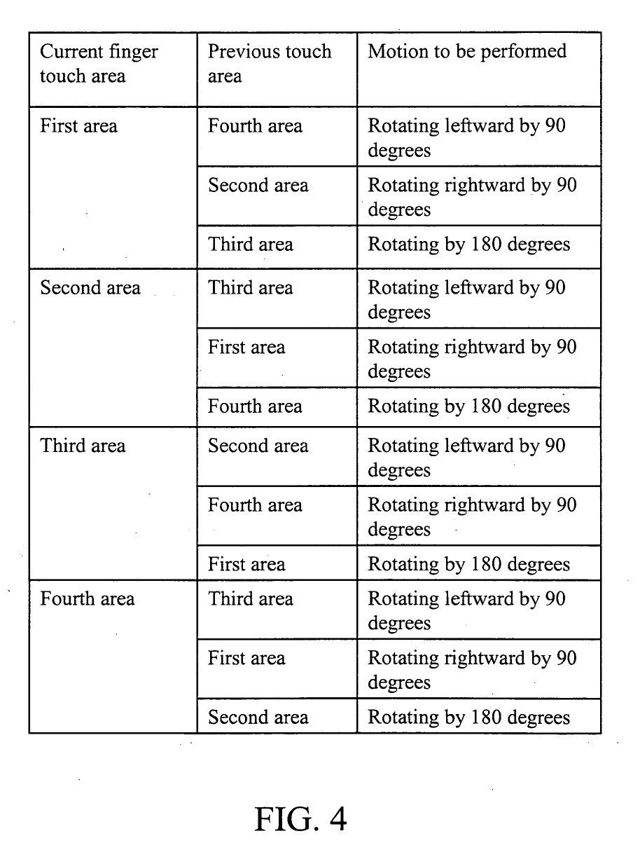

In addition, a method for controlling a direction of an operated target with a computer input device is provided in another embodiment of the present invention. FIG. 3 is a flow chart of a method for controlling a direction of an operated target through using a computer input device. Referring to FIG. 3, first, a finger touch motion received by an optical touch control module of the mouse device is detected (S310); next, a finger touch area where a finger touches the optical touch control module is obtained (S320); then, the corresponding motion to be performed is analyzed through utilizing a motion look-up table according to the finger touch area and a previous touch area (S330); and finally, the corresponding motion is performed to control the direction of the operated target (S340).

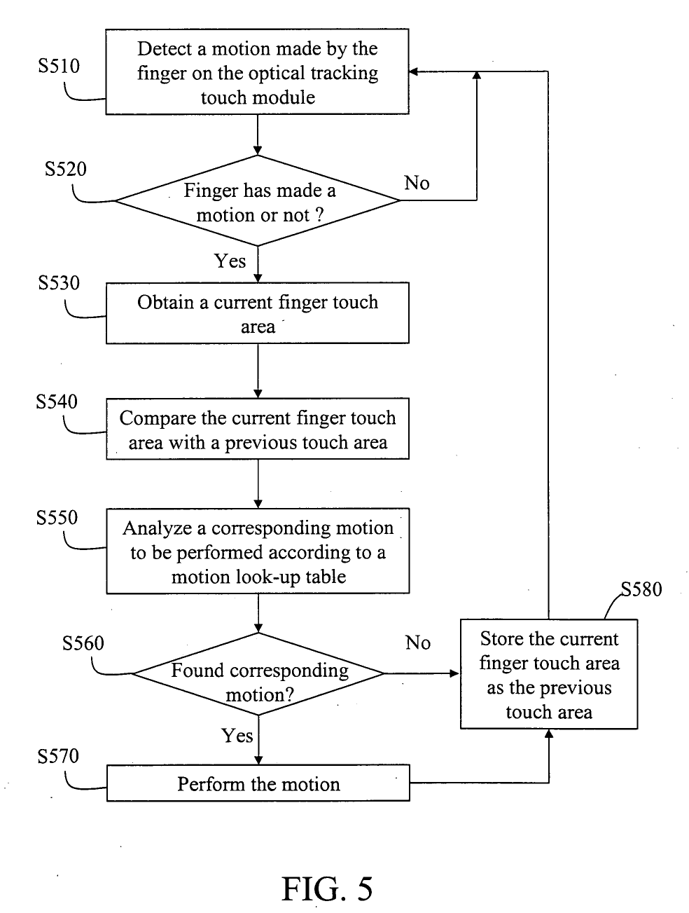

FIG. 4 shows a motion look-up table. Referring to FIG. 4, first of all, the firmware performs an initialization motion to set parameters of the previous touch area and the finger touch area, and then initializes the parameter of the previous touch area into any one of the areas divided on the touch module. Once the finger touches the optical touch control module, a current finger touch area is detected and then the motion look-up table is looked up to analyze the corresponding motion. Then, after the corresponding motion is performed, the current finger touch area is stored as the previous touch area. For example, if the initialized previous touch area is the first area, and the finger of the user slides to the lower portion of the optical touch control module, the current finger touch area detected by the firmware is the third area. At this time, the previous touch area is the first area, and the current finger touch area is the third area. By looking up the motion look-up table, it can be known that the direction of the operated target in the software (if the software is a third-person game, the operated target is the protagonist in the game) should be rotated by 180 degrees. After the operated target is rotated by 180 degrees, the firmware further updates the previous touch area as the third area.

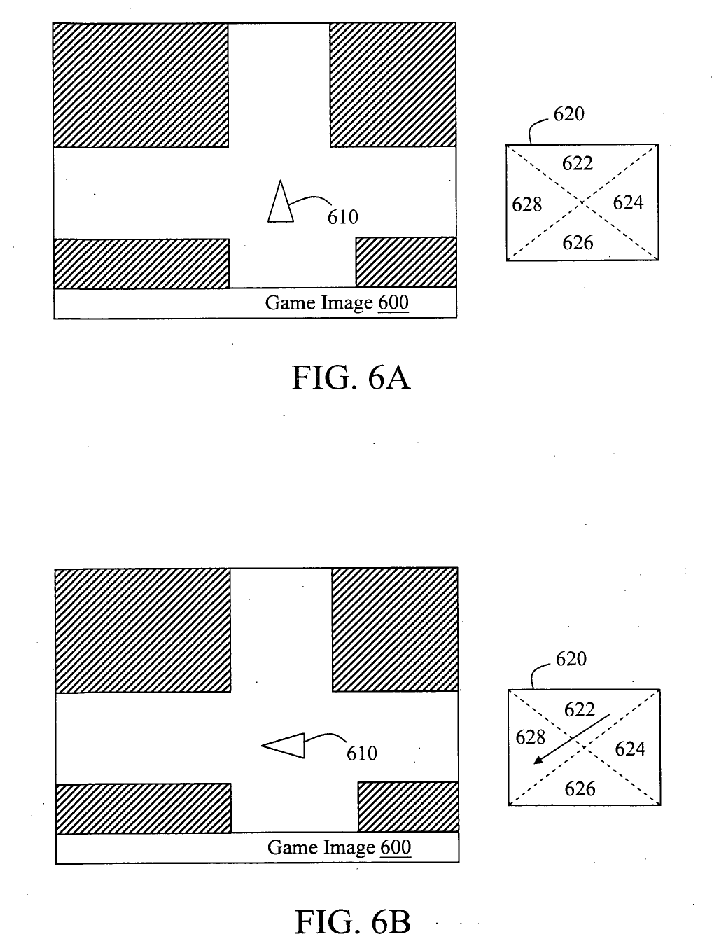

In an alternative embodiment, the corresponding motion to be performed may also be determined according to a depicted curve of the finger touch motion. Relations between the curve and the corresponding motion are listed as follows:
1. when the curve is a clockwise 90-degree curve, the motion is to rotate rightward by 90 degrees;
2. when the curve is an anticlockwise 90-degree curve, the motion is to rotate leftward by 90 degrees;
3. when the curve is a clockwise 180-degree curve, the motion is to rotate by 180 degrees; and
4. when the curve is an anticlockwise 180-degree curve, the motion is to rotate by 180 degrees.
FIG. 5 is a flow chart of a method for controlling a direction of an operated target according to an embodiment of the present invention. Referring to FIG. 5, first, the optical touch control module receives a track depicted by the user when touching the module with a finger, so as to detect a motion made by the finger on the optical touch control module (S510). Once the finger has made a motion (YES in S520), a current finger touch area is obtained (S530); if the finger does not make a motion (NO in S520), it continuously detects a motion made by the finger on the optical touch control module (S510). The firmware obtains the parameter of the current finger touch area and that of a previous touch area for comparison (S540), and then analyzes a corresponding motion to be performed according to a motion look-up table (S550). Once the corresponding motion is found (YES in S560), the motion is performed to control the turning direction of the operated target (S570), and meanwhile, the current finger touch area is stored as the previous touch area (S580), so as to update the parameter of the previous touch area. Moreover, if the corresponding motion is not found (NO in S560), the parameter of the previous touch area should also be updated into that of the current finger touch area.

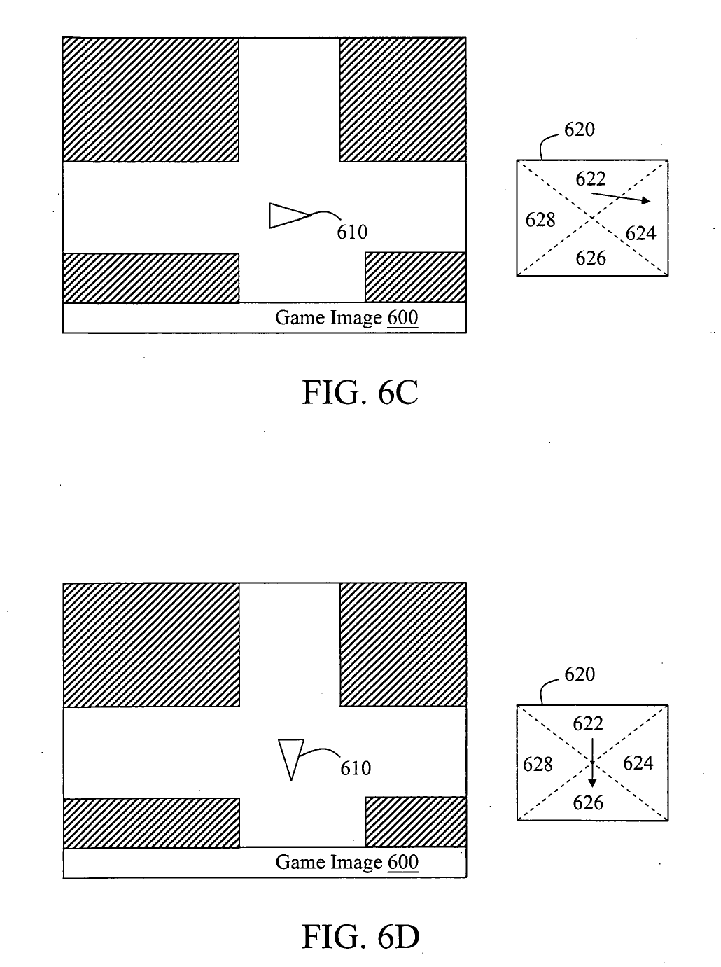

In order to more explicitly illustrate this embodiment, a game software interface is given below as an example. FIGS. 6A to 6D are schematic views for controlling a direction of an operated target. First, referring to FIG. 6A, at the initial stage, an operated target 610 in a game image 600 moves towards the upper portion of the game image, and at this time, the initial parameter of the previous touch area is the first area. The optical touch control module is divided into several sensing areas, for example, an area 620 divided on the touch module in FIG. 6A, which is further divided into four areas: a first area 622, a second area 624, a third area 626, and a fourth area 628.

Referring to FIG. 6B, after the initialization (the parameter of the previous touch area is the first area 622), if the user's finger slides from the first area 622 in the area 620 divided on the optical touch control module to the fourth area 628, a motion made by the finger on the optical touch control module is detected, and the current finger touch area is obtained. Next, the parameter of the previous touch area and that of the current finger touch area are obtained for comparison, and then, through looking up the motion look-up table, the corresponding motion to be performed is analyzed as rotating leftward by 90 degrees. Accordingly, the operated target 610 in the game image 600 is rotated leftward by 90 degrees, such that the operated target 610 turns to move towards the left portion of the game image 600. Once the operated target 610 in the game image 600 is rotated according to the corresponding motion, the parameter of the previous touch area is updated into the fourth area 628.

In view of the above, referring to FIG. 6C, after the initialization (the parameter of the previous touch area is the first area 622), if the user's finger slides from the first area 622 in the area 620 divided on the optical touch control module to the second area 624, the corresponding motion to be performed is found as rotating rightward by 90 degrees through looking up the motion look-up table. Accordingly, the operated target 610 in the game image 600 stops moving upward, but turns to move towards the right portion of the game image 600. Once the operated target 610 in the game image 600 is rotated according to the corresponding motion, the parameter of the previous touch area is updated into the second area 624.

Furthermore, referring to FIG. 6D, after the initialization (the parameter of the previous touch area is the first area 622), if the user's finger slides from the first area 622 in the area 620 divided on the optical touch control module to the third area 626, the corresponding motion to be performed is found as rotating by 180 degrees through looking up the motion look-up table. Accordingly, the operated target 610 in the game image 600 stops moving upwards, but turns to move towards the lower portion of the game image 600. Once the operated target 610 in the game image 600 is rotated according to the corresponding motion, the parameter of the previous touch area is updated into the third area 626.

What is claimed is:

1. A computer input device, suitable for controlling a direction of an operated target in application software, comprising:
an optical touch control module, having a light source, a sensor, and a light pervious element disposed toward the light source and the sensor;
a motion look-up table, for recording operations of a user at the optical touch control module and corresponding motions performed accordingly; and
a corresponding motion look-up means, for controlling the direction of the operated target according to a finger touch motion received by the optical touch control module, wherein the corresponding motion look-up means further comprises:
recording a finger touch area where a finger touches the optical touch control module within a certain time period;
looking up the motion look-up table for the corresponding motion to be performed according to the finger touch area and a record about a previous touch area; and
performing the corresponding motion to control the direction of the operated target.

2. The computer input device according to claim 1, wherein the corresponding motion is one selected from a group consisting of rotating leftward by 90 degrees, rotating rightward by 90 degrees, and rotating by 180 degrees.

3. The computer input device according to claim 1, wherein the finger touch area is any one of several areas divided on the touch module.

4. The computer input device according to claim 1, wherein a firmware further initializes the previous touch area into any one of the several areas divided on the touch module.

5. The computer input device according to claim 1, wherein the firmware further analyzes the corresponding motion by utilizing the motion look-up table, and then stores the current finger touch area as the previous touch area.

6. The computer input device according to claim 1, wherein the firmware further determines the corresponding motion to be performed according to a depicted curve of the finger touch motion.

7. The computer input device according to claim 6, wherein relations between the curve and the corresponding motion are listed as follows:
when the curve is a clockwise 90-degree curve, the motion is to rotate rightward by 90 degrees;
when the curve is an anticlockwise 90-degree curve, the motion is to rotate leftward by 90 degrees;
when the curve is a clockwise 180-degree curve, the motion is to rotate by 180 degrees; and
when the curve is an anticlockwise 180-degree curve, the motion is to rotate by 180 degrees.

8. A method for controlling a direction of an operated target through using a computer input device, wherein the computer input device is used to control the direction of the operated target in application software, the method comprising:
detecting a finger touch motion received by an optical touch control module of the computer input device;
obtaining a finger touch area where a finger touches the optical touch control module;
analyzing the corresponding motion to be performed through utilizing a motion look-up table according to the finger touch area and a previous touch area; and
performing the corresponding motion to control the direction of the operated target.

9. The method for controlling a direction of an operated target through using a computer input device according to claim 8, wherein the corresponding motion is one selected from a group consisting of rotating leftward by 90 degrees, rotating rightward by 90 degrees, and rotating by 180 degrees.

10. The method for controlling a direction of an operated target through using a computer input device according to claim 8, wherein the finger touch area is any one of several areas divided on the touch module.

11. The method for controlling a direction of an operated target through using a computer input device according to claim 8, wherein a firmware further initializes the previous touch area into any one of the areas divided on the touch module.

12. The method for controlling a direction of an operated target through using a computer input device according to claim 8, wherein the firmware further analyzes the corresponding motion by utilizing the motion look-up table, and then stores the current finger touch area as the previous touch area.

13. The method for controlling a direction of an operated target through using a computer input device according to claim 8, wherein the firmware further determines the corresponding motion to be performed according to a depicted curve of the finger touch motion.

14. The method for controlling a direction of an operated target through using a computer input device according to claim 13, wherein relations between the curve and the corresponding motion are listed as follows:
when the curve is a clockwise 90-degree curve, the motion is to rotate rightward by 90 degrees;
when the curve is an anticlockwise 90-degree curve, the motion is to rotate leftward by 90 degrees;
when the curve is a clockwise 180-degree curve, the motion is to rotate by 180 degrees; and
when the curve is an anticlockwise 180-degree curve, the motion is to rotate by 180 degrees.
